(19) United States
(12) Patent Application Publication
(10) Pub. No.: US 2026/0155917 A1
(43) Pub. Date: Jun. 4, 2026

(54) TIME AND FREQUENCY DOMAIN BOUNDARIES FOR INTERFERENCE ESTIMATION IN WIRELESS COMMUNICATIONS

(71) Applicant: QUALCOMM Incorporated, San Diego, CA (US)

(72) Inventors: Chih-Hao LIU, San Diego, CA (US); Jing SUN, San Diego, CA (US); Junyi LI, Greentown, PA (US); Mostafa KHOSHNEVISAN, San Diego, CA (US)

(21) Appl. No.: 18/966,991

(22) Filed: Dec. 3, 2024

(51) Int. Cl. H04L 5/00; H04W 72/1263

(52) U.S. Cl. CPC H04L 5/0005; H04W 72/1263

(57) ABSTRACT

Methods, systems, and devices for wireless communication are described. A user equipment (UE) may receive, from a network entity, a control message that indicates one or more windows within a time or frequency domain for averaging one or more interference estimates, where the windows may be based on a time granularity or frequency granularity of interference sources. In a frequency domain, boundaries of windows may be aligned based on precoding resource block (RB) group (PRG) boundaries. In a time domain, a window may be based on allowable Start and Length Indicators (SLIVs) and slot structure of a network, and may have at least one null frame, or reference signal (e.g., DMRS). In some examples, windows may be based on SLIVs so at least one window is within a SLIV, or SLIVs may be selected based on previously configured windows.

### FIELD OF TECHNOLOGY

The following relates to wireless communication, including time and frequency domain boundaries for interference estimation in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein. For example, a user equipment (UE) may receive, from a network entity, a control message that indicates one or more windows within a time or frequency domain for averaging one or more estimates, where the windows may be based on a time granularity (e.g., a minimum time span) or frequency granularity (e.g., a minimum frequency span) of interference sources. In a frequency domain, windows and associated boundaries for averaged interference estimation may be aligned based on resource block group (e.g., a precoding resource block (RB) group (PRG)) boundaries. In a time domain, windows may be based on allowable SLIVs and slot structure of a network, and may have at least one null frame, or reference signal (e.g., demodulation reference signal (DMRS)), within each window. In some cases, averaging windows may be defined based on SLIVs so at least one averaging window is contained within a SLIV, or SLIVs may be selected based on previously configured windows. Additionally, or alternatively, techniques allowing allocation within or across slot boundaries may be supported (e.g., for a fluid SLIV design).

A method for wireless communications at a user equipment (UE) is described. The method may include receiving a control message that indicates one or more windows within a frequency domain, a time domain, or both, for averaged interference estimation associated with a first cell, the one or more windows based on a time granularity of one or more interference sources, a frequency granularity of the one or more interference sources, or both, and communicating with the first cell based on an averaged interference estimate obtained in accordance with the one or more windows.

An apparatus for wireless communications at a UE is described. The apparatus may include one or more processors and instructions stored in one or more memories. The instructions may be executable by the one or more processors, individually or collectively, to cause the apparatus to receive a control message that indicates one or more windows within a frequency domain, a time domain, or both, for averaged interference estimation associated with a first cell, the one or more windows based on a time granularity of one or more interference sources, a frequency granularity of the one or more interference sources, or both, and communicate with the first cell based on an averaged interference estimate obtained in accordance with the one or more windows.

Another apparatus for wireless communications at a UE is described. The apparatus may include means for receiving a control message that indicates one or more windows within a frequency domain, a time domain, or both, for averaged interference estimation associated with a first cell, the one or more windows based on a time granularity of one or more interference sources, a frequency granularity of the one or more interference sources, or both, and means for communicating with the first cell based on an averaged interference estimate obtained in accordance with the one or more windows.

A non-transitory computer-readable medium storing code for wireless communications is described. The code may include instructions executable by one or more processors to receive a control message that indicates one or more windows within a frequency domain, a time domain, or both, for averaged interference estimation associated with a first cell, the one or more windows based on a time granularity of one or more interference sources, a frequency granularity of the one or more interference sources, or both, and communicate with the first cell based on an averaged interference estimate obtained in accordance with the one or more windows.

In some examples of the method, UEs, and non-transitory computer-readable medium described herein, to indicate the one or more windows, the control message indicates one or more starting boundaries and one or more end boundaries that define the one or more windows.

In some examples of the method, UEs, and non-transitory computer-readable medium described herein, the one or more windows may be aligned within the frequency domain with one or more resource block group boundaries, the frequency granularity being associated with the one or more resource block group boundaries.

In some examples of the method, UEs, and non-transitory computer-readable medium described herein, the one or more resource block group boundaries may be based on a minimum resource block group size.

In some examples of the method, UEs, and non-transitory computer-readable medium described herein, the one or more resource block group boundaries may be based on a resource block group size associated with at least one of the one or more interference sources.

In some examples of the method, UEs, and non-transitory computer-readable medium described herein, operations, features, means, or instructions for communicating with the first cell based on the averaged interference estimate may include operations, features, means, or instructions for transmitting or receiving one or more shared channel messages, where the control message includes a scheduling message that schedules the one or more shared channel messages and indicates the one or more resource block group boundaries, one or more resource block group sizes associated with the one or more resource block group boundaries, a window size associated with the one or more windows, or any combination thereof.

In some examples of the method, UEs, and non-transitory computer-readable medium described herein, the one or more windows within the time domain may be aligned with one or more Start and Length Indicator Values (SLIVs) and one or more slots, the time granularity being associated with the one or more SLIVs and the one or more slots.

In some examples of the method, UEs, and non-transitory computer-readable medium described herein, at least one window of the one or more windows may be included within a corresponding time period for each SLIV of the one or more SLIVs.

In some examples of the method, UEs, and non-transitory computer-readable medium described herein, the one or more SLIVs may be based on the one or more windows.

In some examples of the method, UEs, and non-transitory computer-readable medium described herein, each window of the one or more windows may be within one corresponding slot from among the one or more slots.

In some examples of the method, UEs, and non-transitory computer-readable medium described herein, at least one window of the one or more windows spans a set of multiple slots included in the one or more slots.

In some examples of the method, UEs, and non-transitory computer-readable medium described herein, each window of the one or more windows includes at least one null tone or at least one reference signal, and the averaged interference estimate may be based on the at least one null tone, the at least one reference signal, or both.

In some examples of the method, UEs, and non-transitory computer-readable medium described herein, each window of the one or more windows includes at least one null resource element or at least one symbol of a reference signal, and the averaged interference estimate may be based on the at least one null resource element, the at least one symbol of the reference signal, or both.

A method for wireless communication at a network entity is described. The method may include obtaining scheduling information associated with one or more interference sources associated with one or more neighboring cells for a first cell, the scheduling information indicating a time granularity of the one or more interference sources, a frequency granularity of the one or more interference sources, or both, outputting, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both, and communicating with the UE based on outputting the control message.

An apparatus for wireless communications at a network entity is described. The network entity include one or more processors and instructions stored in one or more memories. The instructions may be executable by the one or more processors, individually or collectively, to cause the apparatus to obtain scheduling information associated with one or more interference sources associated with one or more neighboring cells for a first cell, the scheduling information indicating a time granularity of the one or more interference sources, a frequency granularity of the one or more interference sources, or both, output, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both, and communicate with the UE based on outputting the control message.

Another apparatus for wireless communications at a network entity is described. The network entity may include means for obtaining scheduling information associated with one or more interference sources associated with one or more neighboring cells for a first cell, the scheduling information indicating a time granularity of the one or more interference sources, a frequency granularity of the one or more interference sources, or both, means for outputting, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both, and means for communicating with the UE based on outputting the control message.

A non-transitory computer-readable medium storing code for wireless communications is described. The code may include instructions executable by one or more processors to obtain scheduling information associated with one or more interference sources associated with one or more neighboring cells for a first cell, the scheduling information indicating a time granularity of the one or more interference sources, a frequency granularity of the one or more interference sources, or both, output, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both, and communicate with the UE based on outputting the control message.

In some examples of the method, apparatuses, and non-transitory computer-readable medium described herein, to indicate the one or more windows, the control message indicates one or more starting boundaries and one or more end boundaries that define the one or more windows.

In some examples of the method, apparatuses, and non-transitory computer-readable medium described herein, the one or more windows may be aligned within the frequency domain with one or more resource block group boundaries, the frequency granularity being associated with the one or more resource block group boundaries.

In some examples of the method, apparatuses, and non-transitory computer-readable medium described herein, the one or more resource block group boundaries may be based on a minimum resource block group size.

In some examples of the method, apparatuses, and non-transitory computer-readable medium described herein, the one or more resource block group boundaries may be based on a resource block group size associated with at least one of the one or more interference sources.

In some examples of the method, apparatuses, and non-transitory computer-readable medium described herein, operations, features, means, or instructions for communicating with the first cell based on outputting the control message may include operations, features, means, or instructions for outputting or obtaining one or more shared channel messages, where the control message includes a scheduling message that schedules the one or more shared channel messages and indicates the one or more resource block group boundaries, one or more resource block group sizes associated with the one or more resource block group boundaries, a window size associated with the one or more windows, or any combination thereof.

In some examples of the method, apparatuses, and non-transitory computer-readable medium described herein, the one or more windows within the time domain may be aligned with one or more SLIVs and one or more slots, the time granularity being associated with the one or more SLIVs and the one or more slots.

In some examples of the method, apparatuses, and non-transitory computer-readable medium described herein, at least one window of the one or more windows may be included within a corresponding time period for each SLIV of the one or more SLIVs.

In some examples of the method, apparatuses, and non-transitory computer-readable medium described herein, operations, features, means, or instructions for obtaining the scheduling information associated with the one or more interference sources may include operations, features, means, or instructions for obtaining a set of multiple SLIVs associated with the one or more interference sources and selecting, from among the set of multiple SLIVs associated with the one or more interference sources, the one or more SLIVs such that at least one window of the one or more windows may be included within the corresponding time period for each of the one or more SLIVs.

In some examples of the method, apparatuses, and non-transitory computer-readable medium described herein, each window of the one or more windows may be within one corresponding slot from among the one or more slots.

In some examples of the method, apparatuses, and non-transitory computer-readable medium described herein, at least one window of the one or more windows spans a set of multiple slots included in the one or more slots.

In some examples of the method, apparatuses, and non-transitory computer-readable medium described herein, each window of the one or more windows includes at least one null tone or at least one reference signal, and the averaged interference estimation may be based on the at least one null tone, the at least one reference signal, or both.

In some examples of the method, apparatuses, and non-transitory computer-readable medium described herein, each window of the one or more windows includes at least one null resource element or at least one symbol of a reference signal, and the averaged interference estimation may be based on the at least one null resource element, the at least one symbol of the reference signal, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports time and frequency domain boundaries for interference estimation in wireless communications in accordance with one or more aspects of the present disclosure.

FIG. 2 shows an example of a resource diagram that supports time and frequency domain boundaries for interference estimation in wireless communications in accordance with one or more aspects of the present disclosure.

FIG. 3 shows an example of a frequency domain resource diagram that supports time and frequency domain boundaries for interference estimation in wireless communications in accordance with one or more aspects of the present disclosure.

FIGS. 4A, 4B, and 4C show examples of time domain resource diagrams that support time and frequency domain boundaries for interference estimation in wireless communications in accordance with one or more aspects of the present disclosure.

FIGS. 5 and 6 show block diagrams of devices that support time and frequency domain boundaries for interference estimation in wireless communications in accordance with one or more aspects of the present disclosure.

FIG. 7 shows a block diagram of a communications manager that supports time and frequency domain boundaries for interference estimation in wireless communications in accordance with one or more aspects of the present disclosure.

FIG. 8 shows a diagram of a system including a device that supports time and frequency domain boundaries for interference estimation in wireless communications in accordance with one or more aspects of the present disclosure.

FIGS. 9 and 10 show block diagrams of devices that support time and frequency domain boundaries for interference estimation in wireless communications in accordance with one or more aspects of the present disclosure.

FIG. 11 shows a block diagram of a communications manager that supports time and frequency domain boundaries for interference estimation in wireless communications in accordance with one or more aspects of the present disclosure.

FIG. 12 shows a diagram of a system including a device that supports time and frequency domain boundaries for interference estimation in wireless communications in accordance with one or more aspects of the present disclosure.

FIGS. 13 and 14 show flowcharts illustrating methods that support time and frequency domain boundaries for interference estimation in wireless communications in accordance with one or more aspects of the present disclosure.

### DETAILED DESCRIPTION

Some networks may implement a Start and Length Indicator (SLIV) for scheduling uplink or downlink signaling, where a SLIV may indicate a starting symbol and a quantity of consecutive symbols in the time domain for resource allocation. Networks may also support channel interference estimation, which may in some cases involve averaging interference over one or more SLIVs using an associated demodulation reference signal (DMRS) or other signals. In some cases, to reduce DMRS density and overhead in communications, a SLIV with a DMRS may extend beyond a slot boundary (e.g., a long SLIV), or DMRSs may be shared across multiple SLIVs. However, lowering a density of DMRSs may cause inaccurate interference estimation in the presence of bursty interference. For example, if bursty interference is received within a slot that is missing a DMRS, an averaged interference estimate over a period of time including the slot may not account for interference, reducing an accuracy of the estimate, reducing a gain in signals, as well as increasing a risk of data loss.

In some cases, dedicated null tones or null resource elements may be placed within non-DMRS symbols to enable interference estimation in the presence of bursty interference. However, placing null tones or null resource elements in each frequency resource or each non-DMRS symbol may decrease performance even in the lack of interference, and networks may lack other frameworks or procedures for placing null tones or null resource elements. Additionally, or alternatively, interference estimation averaged across one or more SLIVs may not consider potential frameworks of signaling from interference sources.

Techniques described herein may enable intelligent placement of null tones or resource elements, and selection of boundaries within a time or frequency domain to increase effectiveness in mitigating interference at a user equipment (UE). For example, a UE may receive, from a network entity, a control message that indicates one or more windows within a time or frequency domain for averaging one or more estimates, where the windows may be determined by the network entity based on a time granularity (e.g., a minimum time span) or frequency granularity (e.g., a minimum frequency span) of interference sources. In a frequency domain, a precoding resource block (RB) group (PRG) size may be based on neighboring cells or interference sources, or a minimum PRG size may be defined, where boundaries for averaged interference estimation may be aligned based on PRG boundaries. In a time domain, an averaging window may be defined based on allowable SLIVs and slot structure of a network, and to have at least one null frame, or reference signal (e.g., DMRS), within each window. In some cases, averaging windows may be defined based on SLIVs so at least one averaging window is contained within a SLIV, or SLIVs may be selected based on previously configured windows. Additionally, or alternatively, techniques allowing allocation within or across slot boundaries may be supported (e.g., for a fluid SLIV design).

Using intelligent placement of null tones or resource elements and selection of time or frequency domain averaging boundaries may reduce overhead by reducing a quantity of null tones or null resource elements used, while increasing accuracy in averaged interference estimation and resulting in a relatively higher reliability and gain in communications. For example, windows in the time domain, frequency domain, or both for averaging or otherwise statistically combining or interpolating interference estimates may be based on information about the frequency granularity (e.g., smallest frequency span), temporal granularity (e.g., smallest time span) associated with bursts of interference from one or more interference sources. This may help improve, for example, the accuracy of averaged interference estimates (e.g., based on the averaging or otherwise statistically combining or interpolating of one or more individual interference measurements or estimates) even in the presence of bursty interference, among other potential benefits.

Aspects of the disclosure are initially described in the context of wireless communications systems. Aspects of the disclosure are further illustrated by and described with reference to resource diagrams, frequency domain resource diagrams, and time domain resource diagrams that relate to time and frequency domain boundaries for interference estimation in wireless communications. Aspects of the disclosure are further illustrated by and described with reference to apparatus diagrams, block diagrams, system diagrams, and flowcharts that relate to time and frequency domain boundaries for interference estimation in wireless communications.

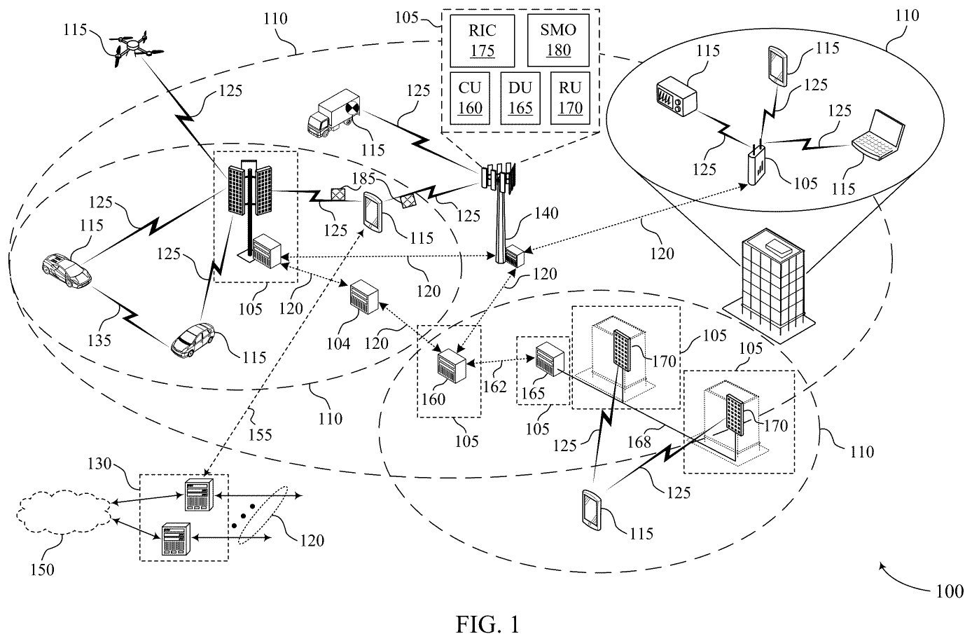

FIG. 1 shows an example of a wireless communications system 100 that supports time and frequency domain boundaries for interference estimation in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support time and frequency domain boundaries for interference estimation in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, the wireless communications system 100 may support defining frequency and time domain averaging boundaries to improve accuracy and reduce overhead in averaged interference estimation at one or more UEs 115. For example, a UE 115 may receive, from a network entity 105, a control message 185 that indicates one or more windows within a time or frequency domain for averaging one or more estimates, where such windows may be determined by the network entity 105 based on a time granularity (e.g., a minimum time span) or frequency granularity (e.g., a minimum frequency span) of interference sources. In a frequency domain a PRG size may be based on neighboring cells or interference sources, or a minimum PRG size may be defined, where boundaries for interference estimation may be aligned based on the PRG boundaries. Additionally, or alternatively, in a time domain, an averaging window may be defined based on allowable SLIVs and slot structure of a network of the wireless communications system 100, and to have at least one null frame, or DMRS, within each window.

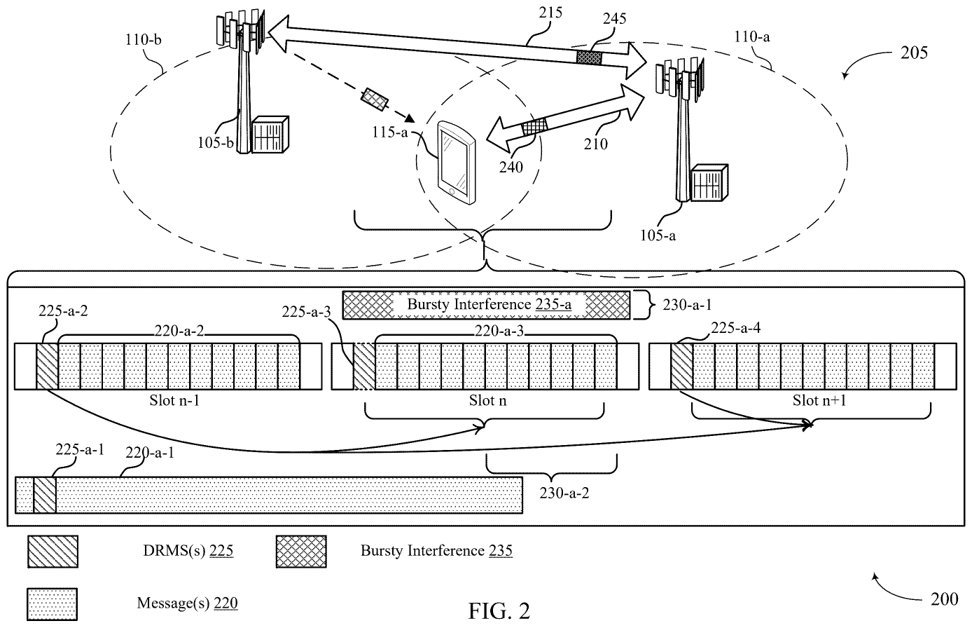

FIG. 2 shows an example of a resource diagram 200 that supports time and frequency domain boundaries for interference estimation in wireless communications in accordance with one or more aspects of the present disclosure. In some examples, the resource diagram 200 may implement or be implemented by aspects of the wireless communications system 100. For example, the resource diagram 200 may illustrate signaling in a network 205 using one or more time and frequency resources, where the network 205 may include one or more network entities 105, including network entities 105-a and 105-b with coverage areas 110-a and 110-b, respectively, and one or more UEs 115, including a UE 115-a, which may represent network entities 105, coverage areas 110, and UEs 115 as described with respect to FIG. 1. In some examples, the UE 115-a may include a communication link 210 (e.g., an uplink communication link, a downlink communication link, or both) with the network entity 105-a, which may be an example of a communication link 125. The network entity 105-a may further include a communication link 215 (e.g., a backhaul link) with the network entity 105-b, which may be an example of a backhaul communication link 120. In some cases, the network 205 may support intelligent placement of null tones or resource elements as well as selection of boundaries within a time or frequency domain to mitigate interference.

For example, the network 205 may in some cases support a fluid SLIV design for one or more signals uplink or downlink signals, as well as for sidelink (e.g., physical sidelink shared channel (PSSCH) communications). For example, one or more messages 220 may represent repeated physical uplink shared channel (PUSCH) (or physical downlink shared channel (PDSCH)) transmissions with multiple segments of back-to-back symbols, which may be introduced to extend PUSCH coverage. In some cases, the repetitions may involve different redundancy versions of PUSCH, and each repetition segment may not cross a slot boundary. In some examples, a fluid SLIV design may allow scheduling of any quantity of symbols for one message or multiple messages (e.g., repetitions) regardless of slot boundary. For example, a long SLIV design may allow a PDSCH or PUSCH allocation for one or more messages 220 to be across a slot boundary and may reduce complexity in designs to extend coverage. In some cases, a message 220-a-1 (e.g., a single transport block (TB), or multiple repetitions) and an associated allocation may extend across a slot boundary of the slot n−1 and the slot n. Further, DMRS overhead reduction design may be implemented by applying a relatively uniform time domain DMRS pattern (e.g., incorporating benefits from DMRS & cell specific reference signal (CRS)) given a Doppler effect. Additionally, or alternatively, a window may extend across both slots n−1 and n and may use a single DMRS 225-a-1 for estimation, opposed to using multiple DMRSs 225 (such as a DMRS 225-a-2 and a DMRS 225-a-3).

In some examples, to reduce a time domain density of DMRSs 225, time domain interpolation may be performed within a window for estimating a channel, where a group of DMRS symbols within a window (e.g., a channel estimate window, a time span) may be used to interpolate a channel. In some examples, the size of a channel estimating window for DMRS bundling may depend on a buffer constraint of a UE 115, and one or more sliding channel estimation windows may overlap.

In some cases, DMRS sharing may be supported across one or more SLIVs. For example, for downlink, a combinable DMRS resource in adjacent TTIs may be indicated to a receiving UE 115, and the UE 115 may be instructed to perform Cross-SLIV combining, which may reduce DMRS overhead. In some examples, a downlink control information (DCI) (or a group-common DCI (GC-DCI)) message may be received in one or more first symbols of the slot n−1, where the DCI may instruct the UE 115-a to buffer the DMRS 225-a-3. In the slot n, the UE 115-a may perform causal combining to extrapolate one or more PDSCH symbols and perform decoding using the DMRS 225-a-2 and DMRS 225-a-3. In some examples, (e.g., low Doppler cases) a cross-slot DMRS pattern may involve one or more slots that lack one or more DMRSs. For example, Cross-SLIV DMRS combining for the slot n may involve a Cross-SLIV DMRS pattern, such as the DMRS 225-a-2, being shared between the slot n−1 and the slot n. In such a case, each of the slots n−1 and n may be associated with separate SLIVs. Further, Cross-SLIV DMRS combining for the slot n+1 may involve a DMRS 225-a-4 combined with the DMRS 225-a-2.

In some examples, the UE 115-a may perform averaged interference estimation for interference caused by one or more sources. For example, averaged interference estimation may involve determining an averaged interference estimate across a window 230, and removing the estimated interference to improve a signal quality. In some examples, DMRS symbols of one or more DMRSs 225 may be used to capture interference and estimate a noise covariance matrix \hat{R}_{NN} (e.g., using one or more algorithms as described herein), which may be used to characterize and correct interference. In some examples, the UE 115-a may receive bursty interference 235 from one or more interference sources that may originate from other cells for one or more edge UEs. For example, bursty interference 235-a may be received from the network entity 105-a, which may be an example of an interference source of an interference cell with a coverage area 110-b. In some cases, interference cells may transmit one slot or one mini-slot. For example, the bursty interference 235-a may be received within the slot n.

Utilizing a fluid SLIV or Cross-SLIV DMRS sharing may result in DMRS symbols being relatively sparse (e.g., for a low Doppler case) and a relatively higher chance for interference to affect non-DMRS symbols, which may prevent interference estimation (e.g., interference cannot be captured in \hat{R}_{NN} estimation). For example, the slot n may lack a DMRS, and so the UE 115-a may be unable to perform averaged interference estimation for the bursty interference 235-a within the slot n. In some cases, interference (e.g., using \hat{R}_{NN}) may be estimated by placing dedicated null tones or null resource elements in each non-DMRS symbol, however, doing so may cause increased overhead and decreased performance.

As described herein, the network 205 may implement intelligent placement of null tones or resource elements, as well as selection of boundaries within a time or frequency domain to mitigate interference while decreasing overhead. For example, the UE 115-a may receive a control message 240 that may indicate one or more windows 230 within a frequency domain, a time domain, or both, for averaged interference estimation. In some cases, the one or more windows 230 may be based on a time granularity of one or more interference sources, a frequency granularity of the one or more interference sources, or both. For example, the control message 240 may indicate a window 230-a-1 including respective boundaries in the frequency domain, where the window 230-a-1 may be used for estimating interference from one or more interference sources. Additionally, or alternatively, the control message 240 may indicate a window 230-a-2 including respective boundaries in the time domain. In some examples, the control message 240 may indicate one or more starting boundaries and one or more end boundaries that may define the one or more windows 230. Additionally, or alternatively, the UE 115-a may receive information regarding frequency or time granularities in the control message 240, and my determine one or more boundaries.

The UE 115-a may communicate with one or more cells or with the network entity 105-a based on an averaged interference estimate obtained in accordance with the one or more windows 230. For example, the network entity 105-a may place one or more null tones, null resource elements, or DMRSs (or other reference signal) so that each window of the one or more windows 230 may include at least a null tone or null resource elements, or a DMRS. Using the null tones, null resource elements, DMRSs, or a combination thereof, the UE 115-a may determine an averaged interference estimate over each window, and may use the one or more estimates to reduce interference and improve communications with the network entity 105-a or one or more cells. Additionally, or alternatively, in place of null tones or null resource elements, a known signal may be transmitted and used to determine interference.

In some examples, the network entity 105-a may obtain scheduling information 245 associated with one or more interference sources, such as one or more neighboring cells, to be used in determining or defining boundaries and windows 230. For example, the scheduling information 245 may be received from the network entity 105-b, as well as from one or more other network entities 105 of other cells. The scheduling information 245 may in some cases indicate a frequency granularity of the one or more interference sources, such as one or more associated PRG sizes, or a time granularity of the one or more interference sources, such as one or more SLIV configurations or minimum SLIV sizes. In some cases, the network entity 105-a may determine one or more windows 230 and associated boundaries using the scheduling information 245.

In some examples, the averaged interference estimation may involve one or more algorithms. For example, in a first algorithm, noise estimation may be based on DMRS tones, and may involve performing a channel estimate first to calculate a channel H, and performing interference estimation calculated using Equation 1 below:

$${\hat{R}}_{NN} = \frac{1}{N} \sum ( {Y}_{i} - {H}_{i} ) {( {Y}_{i} - {H}_{i} )}^{′} \qquad ( 1 )$$

\hat{R}_{NN} may represent the noise covariance matrix, where Yᵢ may be associated with a received signal at the UE 115-a, and Hᵢ may be associated with a known channel. In some cases, the first algorithm may be robust in persistent and no interference cases. Using the noise covariance matrix, an interference may be estimated.

A second algorithm may involve a combined DMRS and null tone based noise estimate. For example, the UE 115 a may use null tones to estimate noise for non-DMRS symbols and may use DMRSs to estimate noise for DMRS symbols to capture bursty noise. Such an approach may provide some accuracy gains but may also involve some incremental complexity relative to DMRS-based noise estimation in accordance with the first algorithm.

A third algorithm may involve calculating R_{yy}, which may represent one or more data tones, where \hat{R}_{NN} may be estimated using the data tones. For example, for a symbol i, Equation 2 may be defined below:

$${R}_{yy} = \frac{1}{N} \sum {Y}_{i} {Y}_{i}^{′} \approx \frac{1}{N} \sum {\hat{H}}_{i} \cdot {\hat{H}}_{i}^{{}_{{}_{′}}} + Δ {H}_{i} Δ {H}_{i}^{′} + {G}_{i} \cdot {G}_{i}^{′} + {n}_{i} \cdot {n}_{i}^{′} \qquad ( 2 )$$

In some examples, cross terms may be ignored from Equation 2. An Equation 3 may be defined for calculating \hat{R}_{NN} based on R_{yy}, as illustrated below:

$${\hat{R}}_{NN} = {R}_{yy} - \frac{1}{N} \sum {\hat{H}}_{i} \cdot {\hat{H}}_{i}^{{}_{{}_{′}}} - {N}_{0} I \qquad ( 3 )$$

In some cases, the third algorithm may capture a spatial signature and may be useful/suitable for interference with relatively little to no rate loss.

In some examples, using intelligent placement of null tones or resource elements, as well as selection of time or frequency domain averaging boundaries based on the scheduling information 245, may result in an increased accuracy in interference estimation, relatively higher reliability in communications, as well as reduce overhead by reducing a quantity of null tones, resource elements, or DMRSs used. Further, interference estimation (e.g., \hat{R}_{NN} estimation) may be averaged across null tones within a PRG or a preconfigured time window based on one or more defined boundaries as described herein. If bursty interference is relatively constant over contiguous RBs or symbols, the UE 115-a may average across null tones, resource elements, or reference signal resource elements in the RBs or symbols. As the UE 115-a or network entity 105-a may be aware of an interference pattern (e.g., the minimum frequency and time span that interference can occupy) based on the scheduling information 245, time or frequency domain averaging boundaries may be configured or derived for the one or more windows 230 to improve estimation by configuring the windows 230 so that averaging is performed over relatively constant bursty interference (e.g., by coordinating a minimum PRG size, SLIV configuration and frame structure using the scheduling information 245). Further, using one or more known signals, such as reference signals (e.g., similar to phase tracking reference signals) may improve throughput similar to using null tones or null resource elements.

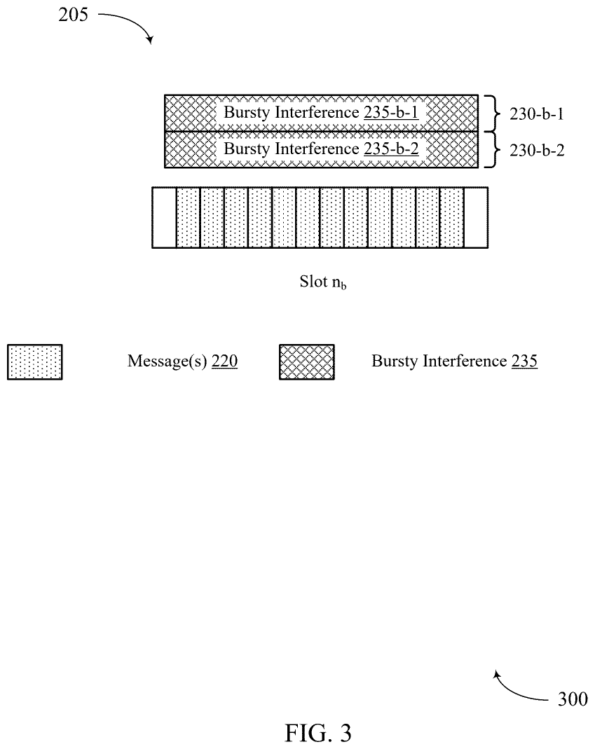

FIG. 3 shows an example of a frequency domain resource diagram 300 that supports time and frequency domain boundaries for interference estimation in wireless communications in accordance with one or more aspects of the present disclosure. In some examples, the frequency domain resource diagram 300 may implement or be implemented by aspects of the wireless communications system 100 and the resource diagram 200. For example, the frequency domain resource diagram 300 may represent communications in the network 205 between the UE 115-a and the network entity 105-a that may experience bursty interference 235-b-1 and 235-b-2 from one or more interference sources during a slot n_{b}. In some cases, the network 205 may support defining one or more windows 230 in a frequency domain for averaged interference estimation as described herein.

In some examples, one or more windows 230, including a window 230-b-1 and a window 230-b-2, may be aligned within the frequency domain with one or more PRG (e.g., resource block group) boundaries, where a frequency granularity may be associated with the PRG boundaries. For example, the network 205 may define frequency domain interference averaging boundaries where one or more interference second statistics are relatively constant within each frequency segment. For example, the window 230-b-1 may correspond to a first PRG and associated boundaries in the frequency domain over which to determine an averaged interference estimate (e.g., using a R_{nn,0}), and the window 230-b-2 may correspond to a second PRG and associated boundaries in the frequency domain over which to determine an averaged interference estimate (e.g., using a R_{nn,1}).

In some examples, the one or more PRG boundaries may be based on a minimum PRG size for the network 205. For example, the windows 230 (e.g., frequency domain \hat{R}_{NN} average boundaries) may be aligned with minimum PRG boundaries within the network 205. In some cases, the network 205 may configure the minimum PRG size for one or more cells and the windows 230 may align with a resulting minimum PRG grid. In such an example, the first and second PRGs may be part of the grid. Additionally, or alternatively, if the network 205 lacks coordination between network entities 105, the minimum PRG size may be set to a preconfigured minimum value (e.g., a minimum PRG size of 2RB). In some examples, a minimum PRG may be preconfigured at the network entity 105-a, or preconfigured at the UE 115-a (e.g., via RRC signaling), where DCI may be omitted.

In some examples, the one or more PRG boundaries (to which the windows 230 are aligned) may be based on a PRG size associated with one or more interference sources. For example, for downlink MU-MIMO, two UEs 115 may be scheduled with overlapping RBs and with different PRG sizes, where a scheduling DCI may indicate to the target UE 115 scheduled PRG size, and the receiver may assume the minimum PRG size. In some examples, the UE 115-a may be unaware of a PRG size of another UE 115. To better estimate MU-MIMO interference from another spatially multiplexed PDSCH or other communication, a scheduling DCI, such as the control message 240, may indicate the PRG size of the interference source or a frequency domain window size for interference averaging based on the other PRG size. For example, the control message 240 may be a scheduling message that schedules one or more shared channel messages (e.g., PUSCH, PDSCH), and may indicate the one or more PRG boundaries, one or more PRG sizes associated with the one or more PRG boundaries, a window size associated with the one or more windows 230-b-1 and 230-b-2, or any combination thereof. Additionally, or alternatively, the UE 115-a may determine one or more boundaries or windows 230 based on indicated PRG sizes or a minimum PRG size.

In some examples, each window 230 of the one or more windows 230 may include at least one null tone or at least one reference signal, where an averaged interference estimate may be based on the at least one null tone, the at least one reference signal, or both. For example, the network entity 105-a may define one or more null tones or reference signals within each of the windows 230-b-1 and 230-b-2. In some cases, placing null tones or DMRSs within windows 230 or boundaries based on PRGs may increase an accuracy of estimation. For example, for the UE 115-a (e.g., a cell edge UE), an interference cell may potentially perform per PRG precoding, so that interference from other cells may be constant per PRG. However, the size of configured PRG may be different from cell to cell as different PRGs may be associated with different precoders. Thus, by defining the windows 230 to align with PRG boundaries based on other cells, interference estimation may be accurately performed for respective boundaries including relatively constant interference associated with a corresponding precoder.

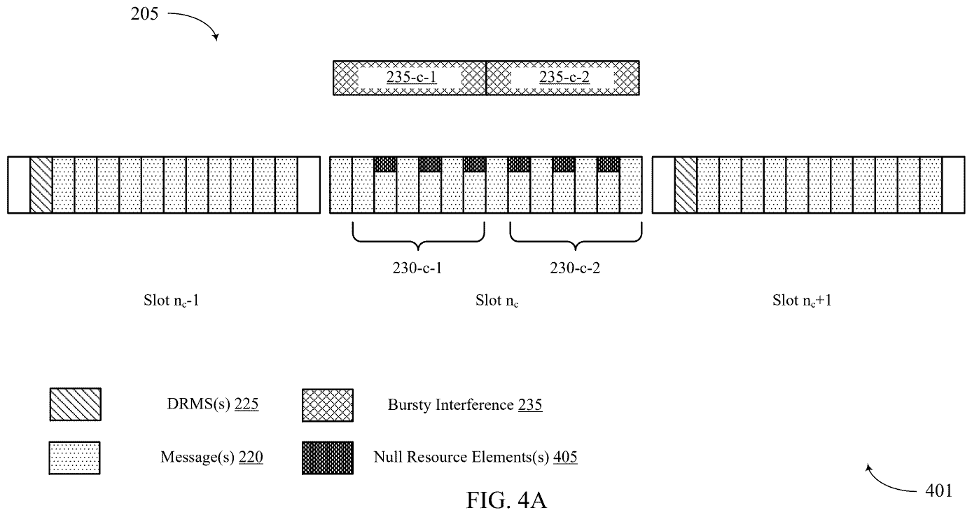

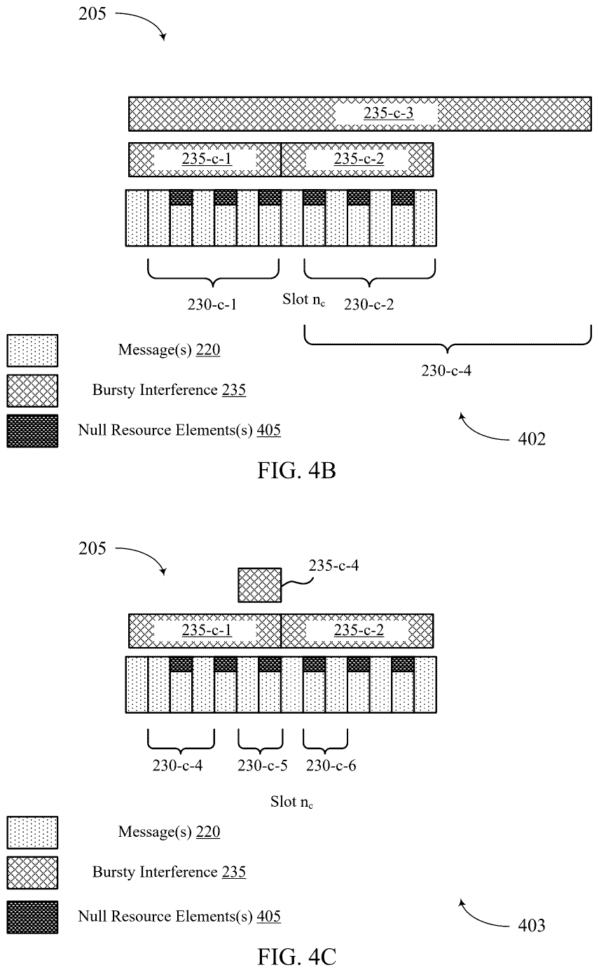

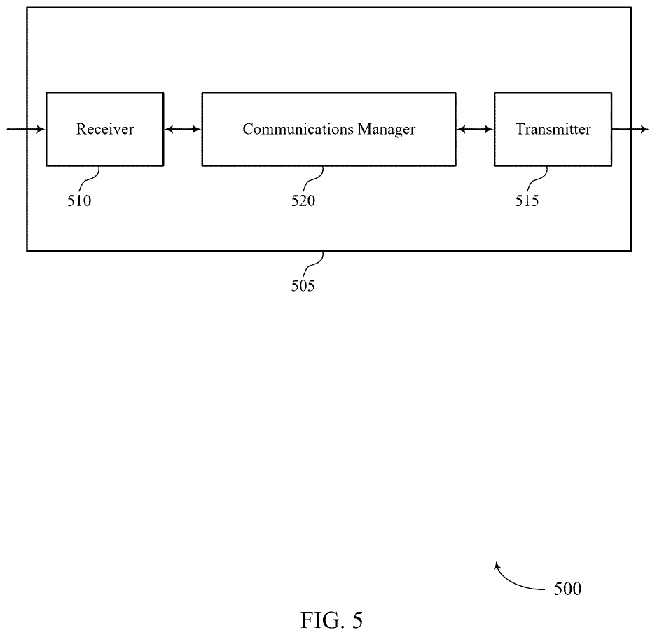

FIGS. 4A, 4B, and 4C show examples of time domain resource diagrams 401, 402, and 403 that support time and frequency domain boundaries for interference estimation in wireless communications in accordance with one or more aspects of the present disclosure. In some examples, the time domain resource diagrams 401, 402, and 403 may implement or be implemented by aspects of the wireless communications system 100, the resource diagram 200, and the frequency domain resource diagram 300. For example, the frequency domain resource diagram 300 may represent communications in the network 205 between the UE 115-a and the network entity 105-a that may experience bursty interference 235-b-1 and 235-b-2 from one or more interference sources during a slot n_{c}. In some cases, the network 205 may support defining one or more windows 230 in a time domain for averaged interference estimation as described herein.

For example, in FIGS. 4A-4C, or more windows 230 within the time domain may be aligned with one or more SLIVs and one or more slots, where a time granularity may be associated with the SLIVs and the slots. Further, one or more time windows may be indicated in a control message 240, among other information.

In the example of FIG. 4A, the network 205 may define common time windows or boundaries (e.g., time domain \hat{R}_{NN} average boundaries) which may define a time segment, or window 230, used for averaged interference estimation based on allowable SLIVS and a slot structure in the network 205. For example, in the time domain, one or more neighboring cells may support fluid SLIV and mini-slots as well as DMRS sharing. In some cases, the network 205 may define a set of allowable SLIVs so that the interference may be estimated in a limited time span according to the defined windows 230.

In some examples, the network entity 105-a (or the UE 115-a) may define a window 230-c-1 and a window 230-c-2 within the slot n_{c}, where the windows 230 may be examples of time windows defined based on SLIV structure of two interference sources, such as the network entity 105-b associated with bursty interference 235-c-1 and another device associating with bursty interference 235-c-2 within the slot n_{c}. In some examples, one or more start and end boundaries may define each window 230. In some examples, the windows 230 may be non-overlapping. Each slot n_{c}, n_{c}−1, and n_{c}+1 may further include one or more messages 220 or a portion of a message 220, while the slots n_{c}−1 and n_{c}+1 may include one or more reference signals, such as DMRSs 225.

In some cases, each window 230 may include at least one null resource element 405, or at least one symbol of a reference signal (e.g., DMRS 225). For example, if a device (e.g., the 115-a, the network entity 105-a) determines that there is no DMRS 225 (e.g., DMRS symbols) in the windows 230-c-1 or 230-c-2 of the slot n_{c}, the device may place one or more null resource elements 405 in the corresponding window 230. Additionally, or alternatively, one or more symbols of a DMRS (or other reference signal) may be placed in the window. An averaged interference estimate over a window 230 may be based on the at least one null resource element, the at least one symbol of the DMRS, or both.

Additionally, or alternatively, for the third algorithm for interference estimation described herein with respect to FIG. 2, a window 230 may lack a null resource element 405 and a reference signal. In some examples, the windows 230 and associated start and end boundaries may be time varying (e.g., different from slot to slot). In some cases, in a TDD frame structure, an “S” slot may be relatively shorter compared to other slots, while in sub-band full duplex (SBFD), in order to capture uplink to downlink interference, windows 230 may not cross between non-SBFD and SBFD slots.

By defining common windows 230 and associated boundaries in the time domain based on SLIVs and slot structure of the network, the network 205 may ensure that there is at least one null resource element 405 or one or more symbols of a DMRS 225 for each possible window 230 in which bursty interference may be received from an interference source, even in the presence of flexible SLIVs or DMRS sharing as described herein.

In the example of FIG. 4B, the network 205 may define windows 230 according to slot boundaries, where one or more start and end boundaries may or may not be across the slot boundary. For example, in some cases, each of the one or more windows 230 may be within a single corresponding slot from among the one or more slots, where the one or more slots may be aligned with the windows, and where boundaries may be defined on a per slot basis and may vary from slot to slot. For example, the windows 230-c-1 and 230-c-2 may be defined to be within the boundaries of the slot n_{c}. In some cases, defining the windows 230-c-1 and 230-c-2 to be within a slot boundary may enable accurate estimation of the bursty interference 235-c-1 and 235-c-2.

In some examples, one or more windows 230 may span a plurality of slots included in the one or more slots, where time varying boundaries may be defined, and a window 230 may cross a slot boundary. For example, a window 230-c-3 may be defined to be across a slot boundary of the slots n_{c} and n_{c}+1, which may enable accurate estimation of cross-boundary interference, such as interference 235-c-3. In some examples, defining boundaries and windows 230 across boundaries may enable use of all symbols when interference is constant across a slot boundary.

In some examples, allowable SLIV patterns in the network 205 may determine a time domain interference pattern, and so may present benefits by configuring the windows 230 and associated boundaries such that the windows 230 are within the intersection of all potential SLIVs. For example, enabling in-slot or cross-slot boundaries may coordinate with SLIVs to support in-slot SLIVs, flexible SLIVs, long SLIVs, as well as Cross-SLIV DMRS sharing as described herein.

In the example of FIG. 4C, the network 205 may define SLIVs and windows 230 with respect to one another so that windows coordinate with SLIVs. For example, at least one window 230 may be included within a respective time period corresponding to each SLIV of the network 205. In some cases, for a subset of SLIVs selected by the network 205 (e.g., by the network entity 105-a, by another device of the network 205), the network entity 105-a may configure the one or more windows 230 and associated start and end boundaries such that for each supported SLIV, at least one window 230 is fully contained within the SLIV. In the example of FIG. 4C, the network entity 105-a may define windows 230-c-4, 230-c-5, and 230-c-6 according to a first SLIV for an interference source causing the bursty interference 235-c-1, a second SLIV for an interference source causing the bursty interference 235-c-2, as well as a third SLIV for a third interference source causing bursty interference 235-c-4. By defining the windows 230 and boundaries accordingly, the network 205 may be configured such that each window 230 may average over a period over which interference is relativity constant. For example, the window 230-c-5 may include a same combination of interference 235-c-1 and 235-c-4. In some cases, the SLIVs may be determined based on the scheduling information 245 indicating supported SLIVs at one or more neighboring cells or interference sources (e.g., in-slot SLIVs, flexible SLIVs, long SLIVs, SLIVs associated with cross-SLIV DMRS sharing).

In some examples, one or more SLIVs may be based on one or more windows 230. For example, the network 205 may configure the one or more windows 230 and associated start and end boundaries first, and may allow the network entity 105-a to select a subset of SLIVs in which a SLIV is able to fully cover one of the windows 230. For example, the network entity 105-a may obtain the scheduling information 245 associated with the one or more interference sources including one or more SLIVs, and may select one or more SLIVs such that at least one window 230 of the one or more windows 230 is included within the respective time period corresponding to each of the one or more SLIVs. In some examples, a boundary configuration may be sent to each network entity 105 (e.g., gNB) in the network 205 for the network entities 105 to select SLIV patterns (e.g., down select SLIV patterns). In some cases, the network entity 105-a may indicate the boundaries to the UE and may indicate one or more selected SLIVs or a maximum allowable SLIV via the control message 240. In some cases, selecting SLIVs based on previously configured windows 230 may reduce an overhead associated with null resource elements or reference signals by preventing relatively small window sizes.

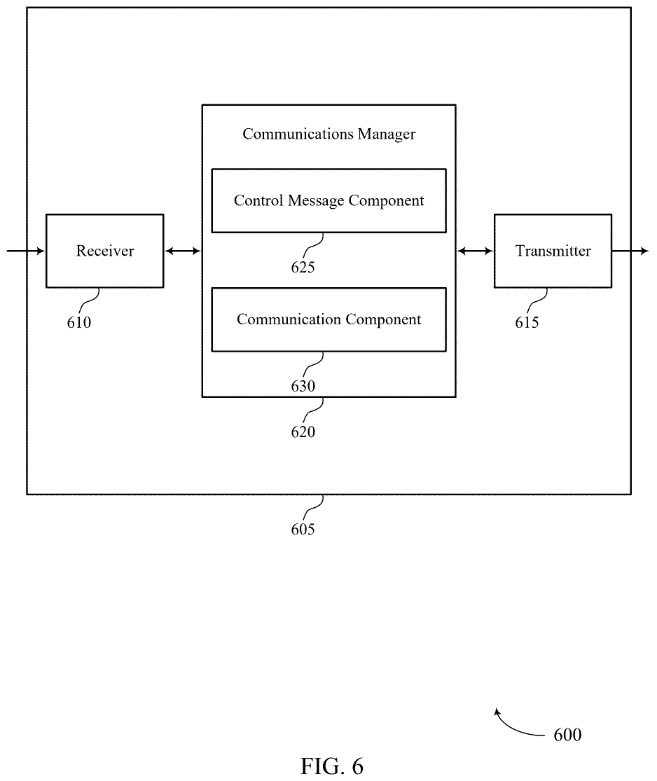

FIG. 5 shows a block diagram 500 of a device 505 that supports time and frequency domain boundaries for interference estimation in wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to time and frequency domain boundaries for interference estimation in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to time and frequency domain boundaries for interference estimation in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of time and frequency domain boundaries for interference estimation in wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving a control message that indicates one or more windows within a frequency domain, a time domain, or both, for averaged interference estimation associated with a first cell, the one or more windows based on a time granularity of one or more interference sources, a frequency granularity of the one or more interference sources, or both. The communications manager 520 is capable of, configured to, or operable to support a means for communicating with the first cell based on an averaged interference estimate obtained in accordance with the one or more windows.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources by reducing overhead associated with DMRSs (or other reference signals), null resource elements, or null tones, as well as increasing a reliability and gain in communications.

FIG. 6 shows a block diagram 600 of a device 605 that supports time and frequency domain boundaries for interference estimation in wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to time and frequency domain boundaries for interference estimation in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to time and frequency domain boundaries for interference estimation in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of time and frequency domain boundaries for interference estimation in wireless communications as described herein. For example, the communications manager 620 may include a control message component 625 a communication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The control message component 625 is capable of, configured to, or operable to support a means for receiving a control message that indicates one or more windows within a frequency domain, a time domain, or both, for averaged interference estimation associated with a first cell, the one or more windows based on a time granularity of one or more interference sources, a frequency granularity of the one or more interference sources, or both. The communication component 630 is capable of, configured to, or operable to support a means for communicating with the first cell based on an averaged interference estimate obtained in accordance with the one or more windows.

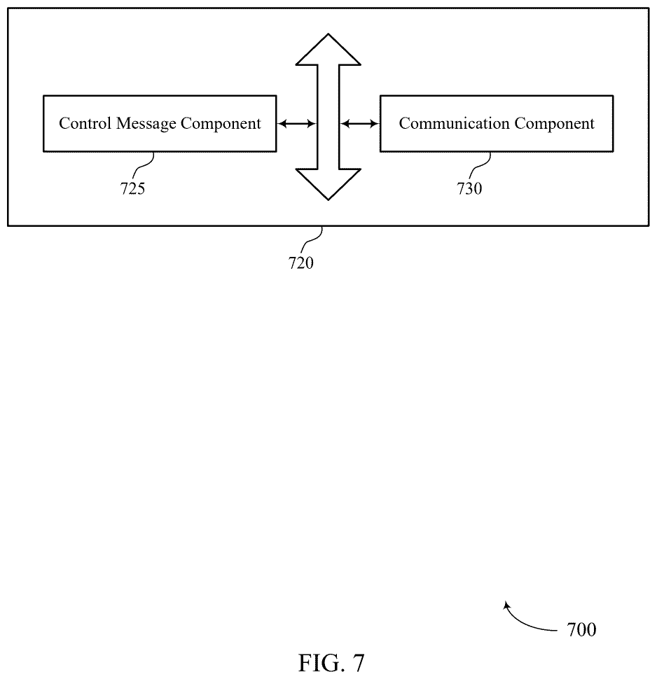

FIG. 7 shows a block diagram 700 of a communications manager 720 that supports time and frequency domain boundaries for interference estimation in wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of time and frequency domain boundaries for interference estimation in wireless communications as described herein. For example, the communications manager 720 may include a control message component 725 a communication component 730, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The control message component 725 is capable of, configured to, or operable to support a means for receiving a control message that indicates one or more windows within a frequency domain, a time domain, or both, for averaged interference estimation associated with a first cell, the one or more windows based on a time granularity of one or more interference sources, a frequency granularity of the one or more interference sources, or both. The communication component 730 is capable of, configured to, or operable to support a means for communicating with the first cell based on an averaged interference estimate obtained in accordance with the one or more windows.

In some examples, to indicate the one or more windows, the control message indicates one or more starting boundaries and one or more end boundaries that define the one or more windows.

In some examples, the one or more windows are aligned within the frequency domain with one or more resource block group boundaries, the frequency granularity being associated with the one or more resource block group boundaries.

In some examples, the one or more resource block group boundaries are based on a minimum resource block group size.

In some examples, the one or more resource block group boundaries are based on a resource block group size associated with at least one of the one or more interference sources.

In some examples, to support communicating with the first cell based on the averaged interference estimate, the communication component 730 is capable of, configured to, or operable to support a means for transmitting or receiving one or more shared channel messages, where the control message includes a scheduling message that schedules the one or more shared channel messages and indicates the one or more resource block group boundaries, one or more resource block group sizes associated with the one or more resource block group boundaries, a window size associated with the one or more windows, or any combination thereof.

In some examples, the one or more windows within the time domain are aligned with one or more SLIVs and one or more slots, the time granularity being associated with the one or more SLIVs and the one or more slots.

In some examples, at least one window of the one or more windows is included within a corresponding time period for each SLIV of the one or more SLIVs.

In some examples, the one or more SLIVs are based on the one or more windows.

In some examples, each window of the one or more windows is within one corresponding slot from among the one or more slots.

In some examples, at least one window of the one or more windows spans a set of multiple slots included in the one or more slots.

In some examples, each window of the one or more windows includes at least one null tone or at least one reference signal. In some examples, the averaged interference estimate is based on the at least one null tone, the at least one reference signal, or both.

In some examples, each window of the one or more windows includes at least one null resource element or at least one symbol of a reference signal. In some examples, the averaged interference estimate is based on the at least one null resource element, the at least one symbol of the reference signal, or both.

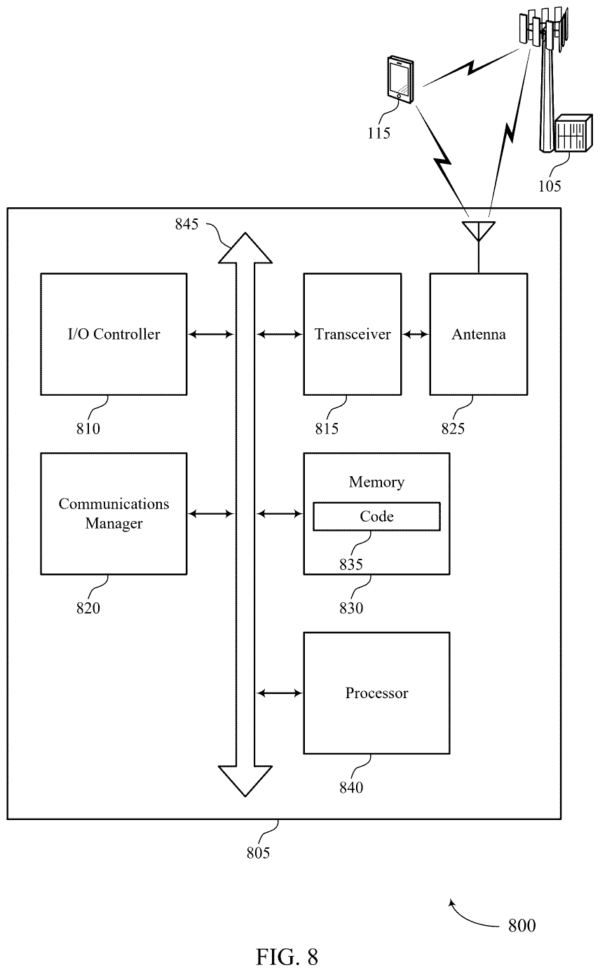

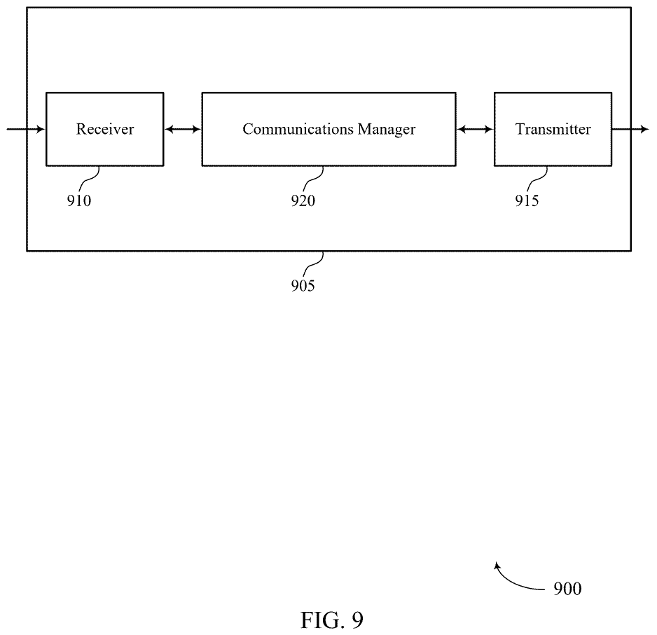

FIG. 8 shows a diagram of a system 800 including a device 805 that supports time and frequency domain boundaries for interference estimation in wireless communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting time and frequency domain boundaries for interference estimation in wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving a control message that indicates one or more windows within a frequency domain, a time domain, or both, for averaged interference estimation associated with a first cell, the one or more windows based on a time granularity of one or more interference sources, a frequency granularity of the one or more interference sources, or both. The communications manager 820 is capable of, configured to, or operable to support a means for communicating with the first cell based on an averaged interference estimate obtained in accordance with the one or more windows.

By including or configuring the communications manager 820 in accordance with examples as described herein, the device 805 may support techniques for improved communication reliability, improved user experience related to reduced processing, reduced power consumption, more efficient utilization of communication resources, and improved coordination between devices by reducing overhead associated with DMRSs (or other reference signals), null resource elements, or null tones, as well as increasing a reliability and gain in communications and supporting additional signaling of information.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of time and frequency domain boundaries for interference estimation in wireless communications as described herein, or the at least one processor 840 and the at least one memory 830 may be otherwise configured to, individually or collectively, perform or support such operations.

FIG. 9 shows a block diagram 900 of a device 905 that supports time and frequency domain boundaries for interference estimation in wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of time and frequency domain boundaries for interference estimation in wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for obtaining scheduling information associated with one or more interference sources associated with one or more neighboring cells for a first cell, the scheduling information indicating a time granularity of the one or more interference sources, a frequency granularity of the one or more interference sources, or both. The communications manager 920 is capable of, configured to, or operable to support a means for outputting, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both. The communications manager 920 is capable of, configured to, or operable to support a means for communicating with the UE based on outputting the control message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources by reducing overhead associated with DMRSs (or other reference signals), null resource elements, or null tones, as well as increasing a reliability and gain in communications.

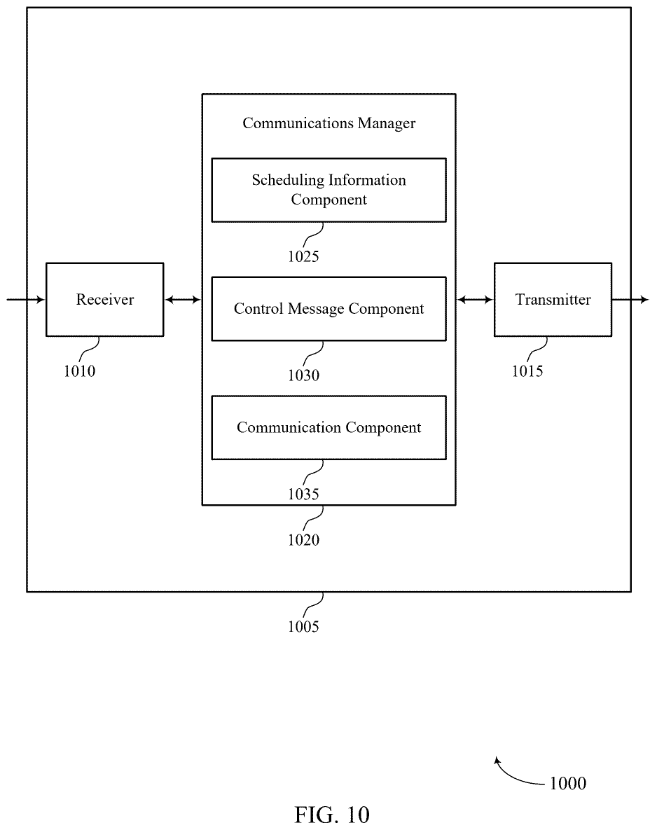

FIG. 10 shows a block diagram 1000 of a device 1005 that supports time and frequency domain boundaries for interference estimation in wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of time and frequency domain boundaries for interference estimation in wireless communications as described herein. For example, the communications manager 1020 may include a scheduling information component 1025, a control message component 1030, a communication component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The scheduling information component 1025 is capable of, configured to, or operable to support a means for obtaining scheduling information associated with one or more interference sources associated with one or more neighboring cells for a first cell, the scheduling information indicating a time granularity of the one or more interference sources, a frequency granularity of the one or more interference sources, or both. The control message component 1030 is capable of, configured to, or operable to support a means for outputting, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both. The communication component 1035 is capable of, configured to, or operable to support a means for communicating with the UE based on outputting the control message.

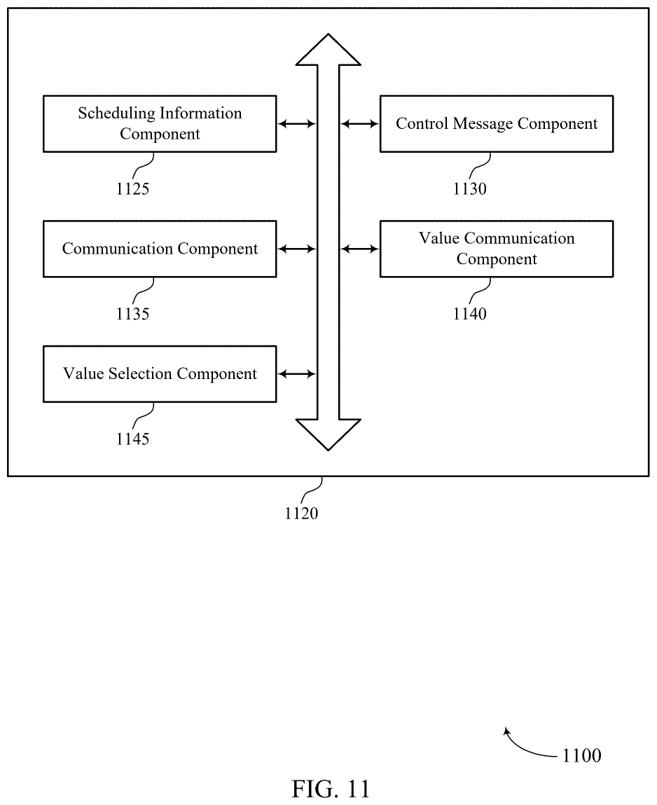

FIG. 11 shows a block diagram 1100 of a communications manager 1120 that supports time and frequency domain boundaries for interference estimation in wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of time and frequency domain boundaries for interference estimation in wireless communications as described herein. For example, the communications manager 1120 may include a scheduling information component 1125, a control message component 1130, a communication component 1135, a value communication component 1140, a value selection component 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The scheduling information component 1125 is capable of, configured to, or operable to support a means for obtaining scheduling information associated with one or more interference sources associated with one or more neighboring cells for a first cell, the scheduling information indicating a time granularity of the one or more interference sources, a frequency granularity of the one or more interference sources, or both. The control message component 1130 is capable of, configured to, or operable to support a means for outputting, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both. The communication component 1135 is capable of, configured to, or operable to support a means for communicating with the UE based on outputting the control message.

In some examples, to indicate the one or more windows, the control message indicates one or more starting boundaries and one or more end boundaries that define the one or more windows.

In some examples, the one or more windows are aligned within the frequency domain with one or more resource block group boundaries, the frequency granularity being associated with the one or more resource block group boundaries.

In some examples, the one or more resource block group boundaries are based on a minimum resource block group size.

In some examples, the one or more resource block group boundaries are based on a resource block group size associated with at least one of the one or more interference sources.

In some examples, to support communicating with the first cell based on outputting the control message, the communication component 1135 is capable of, configured to, or operable to support a means for outputting or obtaining one or more shared channel messages, where the control message includes a scheduling message that schedules the one or more shared channel messages and indicates the one or more resource block group boundaries, one or more resource block group sizes associated with the one or more resource block group boundaries, a window size associated with the one or more windows, or any combination thereof.

In some examples, the one or more windows within the time domain are aligned with one or more SLIVs and one or more slots, the time granularity being associated with the one or more SLIVs and the one or more slots.

In some examples, at least one window of the one or more windows is included within a corresponding time period for each SLIV of the one or more SLIVs.

In some examples, to support obtaining the scheduling information associated with the one or more interference sources, the value communication component 1140 is capable of, configured to, or operable to support a means for obtaining a set of multiple SLIVs associated with the one or more interference sources. In some examples, to support obtaining the scheduling information associated with the one or more interference sources, the value selection component 1145 is capable of, configured to, or operable to support a means for selecting, from among the set of multiple SLIVs associated with the one or more interference sources, the one or more SLIVs such that at least one window of the one or more windows is included within the corresponding time period for each of the one or more SLIVs.

In some examples, each window of the one or more windows is within one corresponding slot from among the one or more slots.

In some examples, at least one window of the one or more windows spans a set of multiple slots included in the one or more slots.

In some examples, each window of the one or more windows includes at least one null tone or at least one reference signal. In some examples, the averaged interference estimation is based on the at least one null tone, the at least one reference signal, or both.

In some examples, each window of the one or more windows includes at least one null resource element or at least one symbol of a reference signal. In some examples, the averaged interference estimation is based on the at least one null resource element, the at least one symbol of the reference signal, or both.

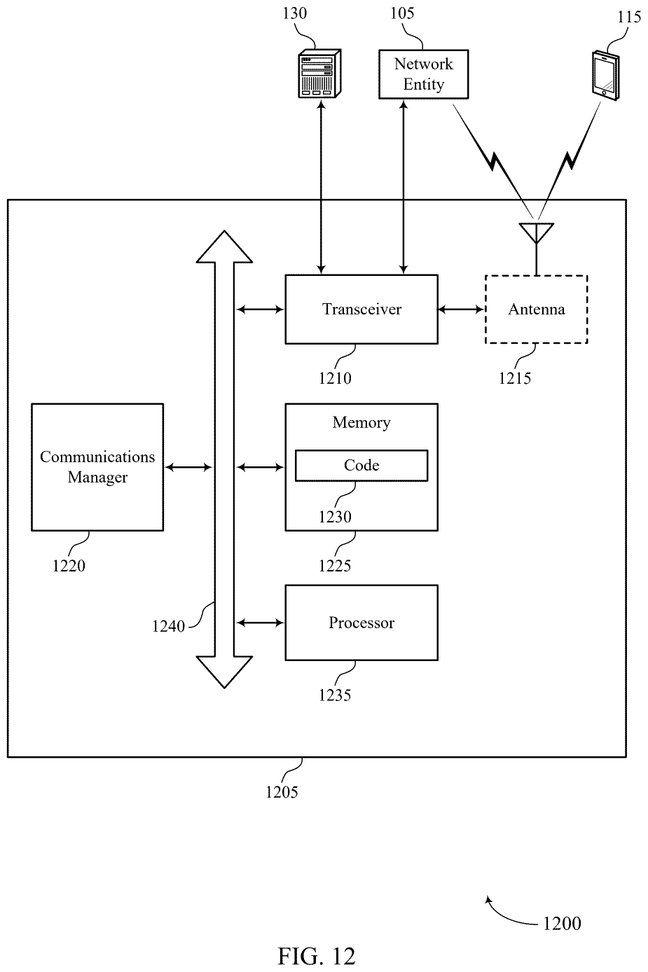

FIG. 12 shows a diagram of a system 1200 including a device 1205 that supports time and frequency domain boundaries for interference estimation in wireless communications in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting time and frequency domain boundaries for interference estimation in wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for obtaining scheduling information associated with one or more interference sources associated with one or more neighboring cells for a first cell, the scheduling information indicating a time granularity of the one or more interference sources, a frequency granularity of the one or more interference sources, or both. The communications manager 1220 is capable of, configured to, or operable to support a means for outputting, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both. The communications manager 1220 is capable of, configured to, or operable to support a means for communicating with the UE based on outputting the control message.

By including or configuring the communications manager 1220 in accordance with examples as described herein, the device 1205 may support techniques for improved communication reliability, improved user experience related to reduced processing, reduced power consumption, more efficient utilization of communication resources, and improved coordination between devices by reducing overhead associated with DMRSs (or other reference signals), null resource elements, or null tones, as well as increasing a reliability and gain in communications and supporting additional signaling of information.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of time and frequency domain boundaries for interference estimation in wireless communications as described herein, or the at least one processor 1235 and the at least one memory 1225 may be otherwise configured to, individually or collectively, perform or support such operations.

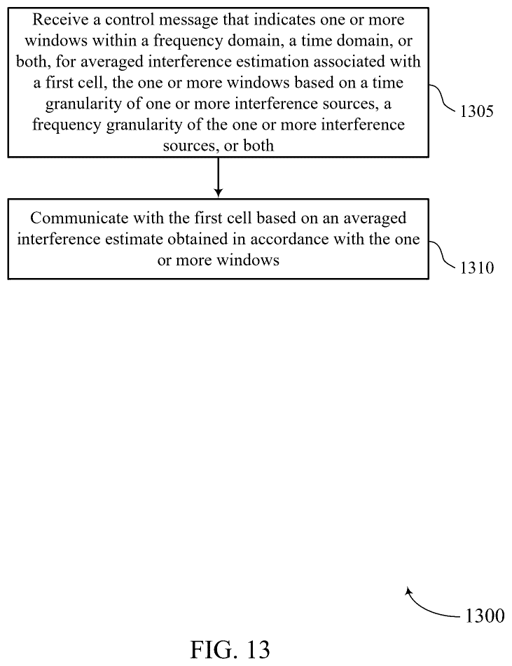

FIG. 13 shows a flowchart illustrating a method 1300 that supports time and frequency domain boundaries for interference estimation in wireless communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message that indicates one or more windows within a frequency domain, a time domain, or both, for averaged interference estimation associated with a first cell, the one or more windows based on a time granularity of one or more interference sources, a frequency granularity of the one or more interference sources, or both. The operations of 1305 may be performed in accordance with examples as disclosed herein. In some examples, aspects of the operations of 1305 may be performed by a control message component 725 as described with reference to FIG. 7.

At 1310, the method may include communicating with the first cell based on an averaged interference estimate obtained in accordance with the one or more windows. The operations of 1310 may be performed in accordance with examples as disclosed herein. In some examples, aspects of the operations of 1310 may be performed by a communication component 730 as described with reference to FIG. 7.

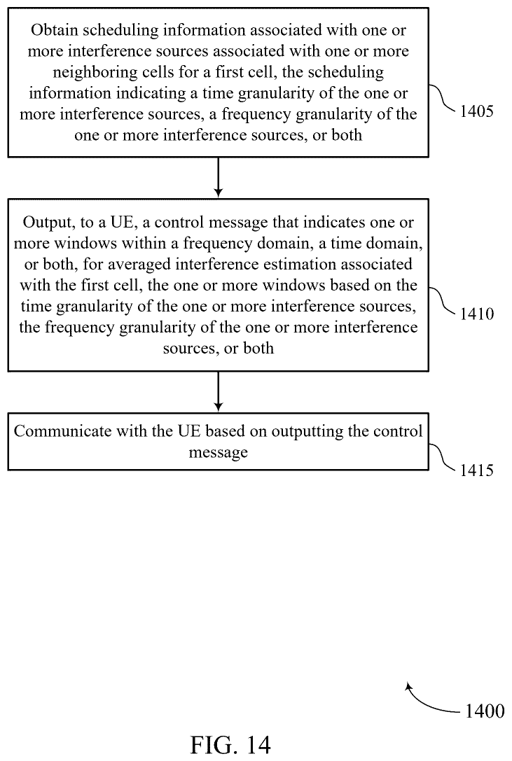

FIG. 14 shows a flowchart illustrating a method 1400 that supports time and frequency domain boundaries for interference estimation in wireless communications in accordance with one or more aspects of the present disclosure. The operations of the method 1400 may be implemented by a network entity or its components as described herein. For example, the operations of the method 1400 may be performed by a network entity as described with reference to FIGS. 1 through 4C and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include obtaining scheduling information associated with one or more interference sources associated with one or more neighboring cells for a first cell, the scheduling information indicating a time granularity of the one or more interference sources, a frequency granularity of the one or more interference sources, or both. The operations of 1405 may be performed in accordance with examples as disclosed herein. In some examples, aspects of the operations of 1405 may be performed by a scheduling information component 1125 as described with reference to FIG. 11.

At 1410, the method may include outputting, to a UE, a control message that indicates one or more windows within a frequency domain, a time domain, or both, for averaged interference estimation associated with the first cell, the one or more windows based on the time granularity of the one or more interference sources, the frequency granularity of the one or more interference sources, or both. The operations of 1410 may be performed in accordance with examples as disclosed herein. In some examples, aspects of the operations of 1410 may be performed by a control message component 1130 as described with reference to FIG. 11.

At 1415, the method may include communicating with the UE based on outputting the control message. The operations of 1415 may be performed in accordance with examples as disclosed herein. In some examples, aspects of the operations of 1415 may be performed by a communication component 1135 as described with reference to FIG. 11.

The following provides an overview of aspects of the present disclosure:
Aspect 1: A method for wireless communications at a UE, comprising: receiving a control message that indicates one or more windows within a frequency domain, a time domain, or both, for averaged interference estimation associated with a first cell, the one or more windows based at least in part on a time granularity of one or more interference sources, a frequency granularity of the one or more interference sources, or both; and communicating with the first cell based at least in part on an averaged interference estimate obtained in accordance with the one or more windows.
Aspect 2: The method of aspect 1, wherein, to indicate the one or more windows, the control message indicates one or more starting boundaries and one or more end boundaries that define the one or more windows.
Aspect 3: The method of any of aspects 1 through 2, wherein the one or more windows are aligned within the frequency domain with one or more resource block group boundaries, the frequency granularity being associated with the one or more resource block group boundaries.
Aspect 4: The method of aspect 3, wherein the one or more resource block group boundaries are based at least in part on a minimum resource block group size.
Aspect 5: The method of any of aspects 3 through 4, wherein the one or more resource block group boundaries are based at least in part on a resource block group size associated with at least one of the one or more interference sources.
Aspect 6: The method of any of aspects 3 through 5, wherein communicating with the first cell based at least in part on the averaged interference estimate comprises: transmitting or receiving one or more shared channel messages, wherein the control message comprises a scheduling message that schedules the one or more shared channel messages and indicates the one or more resource block group boundaries, one or more resource block group sizes associated with the one or more resource block group boundaries, a window size associated with the one or more windows, or any combination thereof.
Aspect 7: The method of any of aspects 1 through 6, wherein the one or more windows within the time domain are aligned with one or more SLIVs and one or more slots, the time granularity being associated with the one or more SLIVs and the one or more slots.
Aspect 8: The method of aspect 7, wherein at least one window of the one or more windows is included within a corresponding time period for each SLIV of the one or more SLIVs.
Aspect 9: The method of aspect 8, wherein the one or more SLIVs are based at least in part on the one or more windows.
Aspect 10: The method of any of aspects 7 through 9, wherein each window of the one or more windows is within one corresponding slot from among the one or more slots.
Aspect 11: The method of any of aspects 7 through 10, wherein at least one window of the one or more windows spans a plurality of slots included in the one or more slots.
Aspect 12: The method of any of aspects 1 through 11, wherein each window of the one or more windows comprises at least one null tone or at least one reference signal, and the averaged interference estimate is based at least in part on the at least one null tone, the at least one reference signal, or both.
Aspect 13: The method of any of aspects 1 through 12, wherein each window of the one or more windows comprises at least one null resource element or at least one symbol of a reference signal, and the averaged interference estimate is based at least in part on the at least one null resource element, the at least one symbol of the reference signal, or both.
Aspect 14: A method for wireless communications at a network entity, comprising: obtaining scheduling information associated with one or more interference sources associated with one or more neighboring cells for a first cell, the scheduling information indicating a time granularity of the one or more interference sources, a frequency granularity of the one or more interference sources, or both; outputting, to a UE, a control message that indicates one or more windows within a frequency domain, a time domain, or both, for averaged interference estimation associated with the first cell, the one or more windows based at least in part on the time granularity of the one or more interference sources, the frequency granularity of the one or more interference sources, or both; and communicating with the UE based at least in part on outputting the control message.
Aspect 15: The method of aspect 14, wherein, to indicate the one or more windows, the control message indicates one or more starting boundaries and one or more end boundaries that define the one or more windows.
Aspect 16: The method of any of aspects 14 through 15, wherein the one or more windows are aligned within the frequency domain with one or more resource block group boundaries, the frequency granularity being associated with the one or more resource block group boundaries.
Aspect 17: The method of aspect 16, wherein the one or more resource block group boundaries are based at least in part on a minimum resource block group size.
Aspect 18: The method of any of aspects 16 through 17, wherein the one or more resource block group boundaries are based at least in part on a resource block group size associated with at least one of the one or more interference sources.
Aspect 19: The method of any of aspects 16 through 18, wherein communicating with the first cell based at least in part on outputting the control message comprises: outputting or obtaining one or more shared channel messages, wherein the control message comprises a scheduling message that schedules the one or more shared channel messages and indicates the one or more resource block group boundaries, one or more resource block group sizes associated with the one or more resource block group boundaries, a window size associated with the one or more windows, or any combination thereof.
Aspect 20: The method of any of aspects 14 through 19, wherein the one or more windows within the time domain are aligned with one or more SLIVs and one or more slots, the time granularity being associated with the one or more SLIVs and the one or more slots.
Aspect 21: The method of aspect 20, wherein at least one window of the one or more windows is included within a corresponding time period for each SLIV of the one or more SLIVs.
Aspect 22: The method of aspect 21, wherein obtaining the scheduling information associated with the one or more interference sources comprises: obtaining a plurality of SLIVs associated with the one or more interference sources; and selecting, from among the plurality of SLIVs associated with the one or more interference sources, the one or more SLIVs such that at least one window of the one or more windows is included within the corresponding time period for each of the one or more SLIVs.
Aspect 23: The method of any of aspects 20 through 22, wherein each window of the one or more windows is within one corresponding slot from among the one or more slots.
Aspect 24: The method of any of aspects 20 through 23, wherein at least one window of the one or more windows spans a plurality of slots included in the one or more slots.
Aspect 25: The method of any of aspects 14 through 24, wherein each window of the one or more windows comprises at least one null tone or at least one reference signal, and the averaged interference estimation is based at least in part on the at least one null tone, the at least one reference signal, or both.
Aspect 26: The method of any of aspects 14 through 25, wherein each window of the one or more windows comprises at least one null resource element or at least one symbol of a reference signal, and the averaged interference estimation is based at least in part on the at least one null resource element, the at least one symbol of the reference signal, or both.
Aspect 27: An apparatus for wireless communications at a UE, comprising one or more processors; and instructions stored in one or more memories and executable by the one or more processors, individually or collectively, to cause the apparatus to perform a method of any of aspects 1 through 13.
Aspect 28: An apparatus for wireless communications at a UE, comprising at least one means for performing a method of any of aspects 1 through 13.
Aspect 29: A non-transitory computer-readable medium storing code for wireless communications, the code comprising instructions executable by one or more processors to perform a method of any of aspects 1 through 13.
Aspect 30: An apparatus for wireless communications at a network entity, comprising one or more processors; and instructions stored in one or more memories and executable by the one or more processors, individually or collectively, to cause the apparatus to perform a method of any of aspects 14 through 26.
Aspect 31: An apparatus for wireless communications at a network entity, comprising at least one means for performing a method of any of aspects 14 through 26.
Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors; and
instructions stored in one or more memories and executable by the one or more processors, individually or collectively, to cause the apparatus to:
receive a control message that indicates one or more windows within a frequency domain, a time domain, or both, for averaged interference estimation associated with a first cell, the one or more windows based at least in part on a time granularity of one or more interference sources, a frequency granularity of the one or more interference sources, or both; and
communicate with the first cell based at least in part on an averaged interference estimate obtained in accordance with the one or more windows.

2. The apparatus of claim 1, wherein, to indicate the one or more windows, the control message indicates one or more starting boundaries and one or more end boundaries that define the one or more windows.

3. The apparatus of claim 1, wherein the one or more windows are aligned within the frequency domain with one or more resource block group boundaries, the frequency granularity being associated with the one or more resource block group boundaries.

4. The apparatus of claim 3, wherein the one or more resource block group boundaries are based at least in part on a minimum resource block group size.

5. The apparatus of claim 3, wherein the one or more resource block group boundaries are based at least in part on a resource block group size associated with at least one of the one or more interference sources.

6. The apparatus of claim 3, wherein, to communicate with the first cell based at least in part on the averaged interference estimate, the instructions are executable by the one or more processors, individually or collectively, to cause the apparatus to:
transmit or receive one or more shared channel messages, wherein the control message comprises a scheduling message that schedules the one or more shared channel messages and indicates the one or more resource block group boundaries, one or more resource block group sizes associated with the one or more resource block group boundaries, a window size associated with the one or more windows, or any combination thereof.

7. The apparatus of claim 1, wherein the one or more windows within the time domain are aligned with one or more start and length indicator values and one or more slots, the time granularity being associated with the one or more start and length indicator values and the one or more slots.

8. The apparatus of claim 7, wherein at least one window of the one or more windows is included within a corresponding time period for each start and length indicator value of the one or more start and length indicator values.

9. The apparatus of claim 8, wherein the one or more start and length indicator values are based at least in part on the one or more windows.

10. The apparatus of claim 7, wherein each window of the one or more windows is within one corresponding slot from among the one or more slots.

11. The apparatus of claim 7, wherein at least one window of the one or more windows spans a plurality of slots included in the one or more slots.

12. The apparatus of claim 1, wherein:
each window of the one or more windows comprises at least one null tone or at least one reference signal, and
the averaged interference estimate is based at least in part on the at least one null tone, the at least one reference signal, or both.

13. The apparatus of claim 1, wherein:
each window of the one or more windows comprises at least one null resource element or at least one symbol of a reference signal, and
the averaged interference estimate is based at least in part on the at least one null resource element, the at least one symbol of the reference signal, or both.

14. An apparatus for wireless communications at a network entity, comprising:
one or more processors; and
instructions stored in one or more memories and executable by the one or more processors, individually or collectively, to cause the apparatus to:
obtain scheduling information associated with one or more interference sources associated with one or more neighboring cells for a first cell, the scheduling information indicating a time granularity of the one or more interference sources, a frequency granularity of the one or more interference sources, or both;
output, to a user equipment (UE), a control message that indicates one or more windows within a frequency domain, a time domain, or both, for averaged interference estimation associated with the first cell, the one or more windows based at least in part on the time granularity of the one or more interference sources, the frequency granularity of the one or more interference sources, or both; and
communicate with the UE based at least in part on outputting the control message.

15. The apparatus of claim 14, wherein, to indicate the one or more windows, the control message indicates one or more starting boundaries and one or more end boundaries that define the one or more windows.

16. The apparatus of claim 14, wherein the one or more windows are aligned within the frequency domain with one or more resource block group boundaries, the frequency granularity being associated with the one or more resource block group boundaries.

17. The apparatus of claim 16, wherein the one or more resource block group boundaries are based at least in part on a minimum resource block group size.

18. The apparatus of claim 16, wherein the one or more resource block group boundaries are based at least in part on a resource block group size associated with at least one of the one or more interference sources.

19. The apparatus of claim 16, wherein, to communicate with the first cell based at least in part on outputting the control message, the instructions are executable by the one or more processors, individually or collectively, to cause the apparatus to:
output or obtain one or more shared channel messages, wherein the control message comprises a scheduling message that schedules the one or more shared channel messages and indicates the one or more resource block group boundaries, one or more resource block group sizes associated with the one or more resource block group boundaries, a window size associated with the one or more windows, or any combination thereof.

20. The apparatus of claim 14, wherein the one or more windows within the time domain are aligned with one or more start and length indicator values and one or more slots, the time granularity being associated with the one or more start and length indicator values and the one or more slots.

21. The apparatus of claim 20, wherein at least one window of the one or more windows is included within a corresponding time period for each start and length indicator value of the one or more start and length indicator values.

22. The apparatus of claim 21, wherein, to obtain the scheduling information associated with the one or more interference sources, the instructions are executable by the one or more processors, individually or collectively, to cause the apparatus to:
obtain a plurality of start and length indicator values associated with the one or more interference sources; and
select, from among the plurality of start and length indicator values associated with the one or more interference sources, the one or more start and length indicator values such that at least one window of the one or more windows is included within the corresponding time period for each of the one or more start and length indicator values.

23. The apparatus of claim 20, wherein each window of the one or more windows is within one corresponding slot from among the one or more slots.

24. The apparatus of claim 20, wherein at least one window of the one or more windows spans a plurality of slots included in the one or more slots.

25. The apparatus of claim 14, wherein:
each window of the one or more windows comprises at least one null tone or at least one reference signal, and
the averaged interference estimation is based at least in part on the at least one null tone, the at least one reference signal, or both.

26. The apparatus of claim 14, wherein:
each window of the one or more windows comprises at least one null resource element or at least one symbol of a reference signal, and
the averaged interference estimation is based at least in part on the at least one null resource element, the at least one symbol of the reference signal, or both.

27. A method for wireless communication at a user equipment (UE), comprising:
receiving a control message that indicates one or more windows within a frequency domain, a time domain, or both, for averaged interference estimation associated with a first cell, the one or more windows based at least in part on a time granularity of one or more interference sources, a frequency granularity of the one or more interference sources, or both; and
communicating with the first cell based at least in part on an averaged interference estimate obtained in accordance with the one or more windows.

28. The method of claim 27, wherein, to indicate the one or more windows, the control message indicates one or more starting boundaries and one or more end boundaries that define the one or more windows.

29. A method for wireless communication at a network entity, comprising:
obtaining scheduling information associated with one or more interference sources associated with one or more neighboring cells for a first cell, the scheduling information indicating a time granularity of the one or more interference sources, a frequency granularity of the one or more interference sources, or both;
outputting, to a user equipment (UE), a control message that indicates one or more windows within a frequency domain, a time domain, or both, for averaged interference estimation associated with the first cell, the one or more windows based at least in part on the time granularity of the one or more interference sources, the frequency granularity of the one or more interference sources, or both; and
communicating with the UE based at least in part on outputting the control message.

30. The method of claim 29, wherein, to indicate the one or more windows, the control message indicates one or more starting boundaries and one or more end boundaries that define the one or more windows.
